(19) United States
(12) Patent Application Publication
(10) Pub. No.: US 2007/0121984 A1
(43) Pub. Date: May 31, 2007

(54) Multi-functional earphone cum microphone

(76) Inventors: Po-An Chen, Taipei (TW); Hsiao-Ching Lu, Taipei (TW)

Correspondence Address: LEONG C LEI, PMB # 1008, 1867 YGNACIO VALLEY ROAD, WALNUT CREEK, CA, 94598, US

(21) Appl. No.: 11/268,538

(22) Filed: Nov. 8, 2005

(51) Int. Cl. H04R 11/04; H04R 17/02; H04R 19/04; H04R 21/02; H04R 9/08

(52) U.S. Cl. 381/367

(57) ABSTRACT

A multi-functional earphone cum microphone is disclosed. The device comprises an earphone, a microphone, a call-transferring box and transmission cable or wire, characterized in that the earphone includes a main earphone and a secondary earphone being connected by a connection wire, and from the interior of the main earphone, a specific length of earphone signal wire is extended and the end head of the signal wire is mounted with the call-transferring box having a connection male socket for the linkage with connector of any transmission source.

### BACKGROUND OF THE INVENTION

(a) Technical Field of the Invention

The present invention relates to an earphone cum microphone, and in particular, an earphone cum microphone structure provided with independent transmission connector allowing adaptor of various connector for entertainments such as MP3, Creative Destruction, or computer application such as MSN, SKYPE, or communication such as handphone.

(b) Description of the Prior Art

In conventional earphone and microphone technology the user of the earphone and microphone is restricted by the connector of the device and the female connector of the sound source. In other words, if the earphone and the microphone are not corresponding transmission signal connectors, signal transmission is not possible. As a result, the application of earphone and microphone is very restricted, and therefore, consumers are required to buy separate microphone or earphone for entertainment or PC application, which is a burden to consumer and is inconvenient to the user.

In some conventional microphone cum earphone devices have transmission cables which are extended from the earphone. The outermost end of the device is a signal plug which is adapted to a specific sound source. If the earphone is to be provided with a microphone, the extended transmission cable is mounted with a microphone. This is the structure of earphone cum microphone structure available in the market. The drawback of the conventional earphone cum microphone has been mentioned earlier, wherein the application of the earphone and microphone is depending on the transmission connector and the female connector of the sound source.

In view of the above, it is an object of the present invention to provide a novel structure of earphone cum microphone which mitigates the above drawbacks.

### SUMMARY OF THE INVENTION

The primary purpose of the present invention is to provide a multi-functional earphone cum microphone device with independent transmission connector comprising an earphone, a microphone, a call-transferring box and transmission cable or wire, characterized in that the earphone includes a main earphone and a secondary earphone being connected by a connection wire, and from the interior of the main earphone, a specific length of earphone signal wire is extended and the end head of the signal wire is mounted with the call-transferring box having a connection male socket for the linkage with connector of any transmission source.

Yet still another object of the present invention is to provide a multi-functional earphone cum microphone, wherein the call-transferring box is a minute box body having on/off switches, volume adjusting button, microphone receiving port and components of corresponding socket.

A further object of the present invention is to provide a multi-functional earphone cum microphone, wherein the microphone is mounted either within the box body of the earphone cum microphone device or is connected separately.

Yet a further object of the present invention is to provide a multi-functional earphone cum microphone, wherein the transmission wire comprises two ends provided respectively with a male connector at one end to connect with the female socket on the call-transferring box and a connector for connecting with entertainment, work application and communication audio supplies.

Other objects, and advantages of the present invention can be more fully understood by reading the following detailed description of the preferred embodiment, with reference to the accompanying drawings.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the preferred embodiment of the present invention.

FIG. 2 schematically shows the top view of the call-transferring box of the present invention.

FIG. 3 is a first preferred embodiment of the transmission wire and plug of the present invention.

FIG. 4 is a second preferred embodiment of the transmission wire and plug of the present invention.

FIG. 5 is a third preferred embodiment of the transmission wire and plug of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

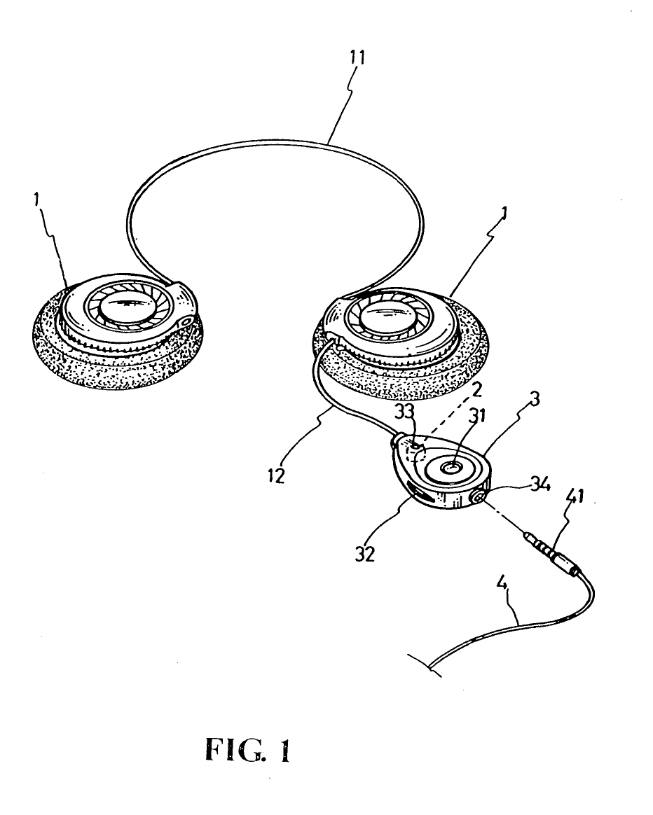

Referring to FIG. 1, there is shown the preferred embodiment of an earphone and microphone device comprising an earphone 1, a microphone 2, a call-transferring box 3 and a plurality of adapting transmission wire 4. The earphone 1 includes a main and secondary earphone 1, and the earphones are connected with a wire within a hollow tube 11. The interior of the main earphone 1 is extended to an earphone signal transmission cable 12 of a specific length. The end head of the specific length transmission cable 12 is connected to the call-transferring box 3 for the mounting or connection of other transmission cable connector.

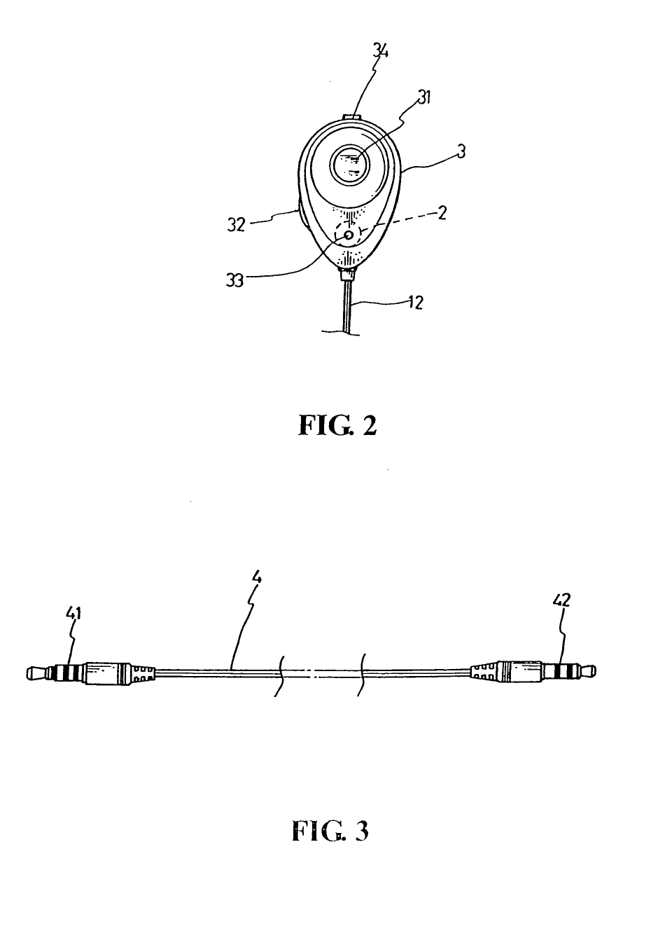

As shown in FIG. 2, the call-transferring box 3 is a minute box structure, and the microphone 2 is provided within the box body 3, or is connected externally and independently. The call-transferring box includes a switch button 31, a volume adjustment button 32, a microphone receiving port 33, and a front loading female socket 34. The switch button 31 is a switch to control the switching on and switching off of the microphone, and the volume adjustment button 32 is used to control the volume of the speaker of the earphone. The female socket 34 provides connection to the connector 41 of various transmission cable 4 so as to be adapted to technological devices with an earphone cum microphone.

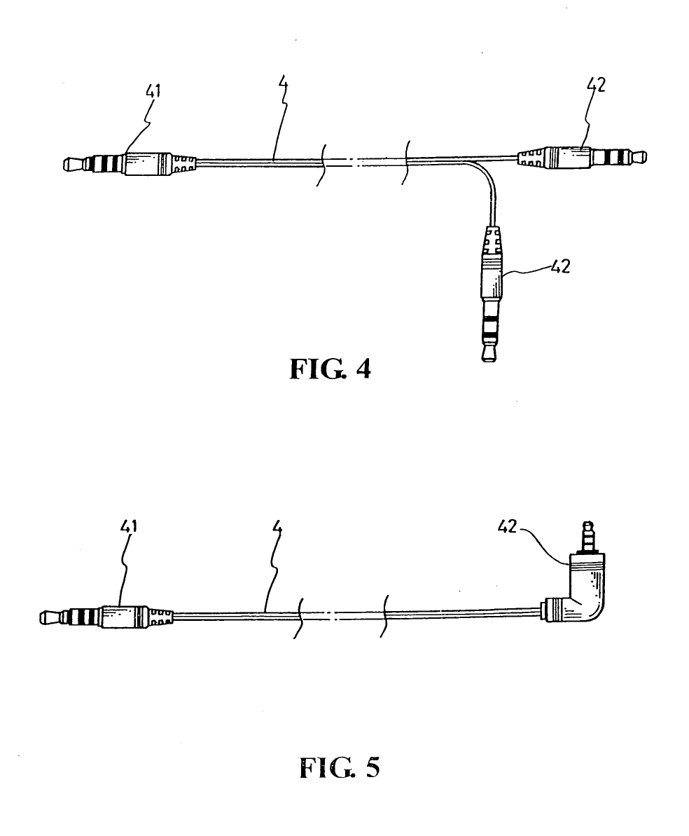

As shown in FIGS. 3, 4 and 5, there are shown various transmission cable 4 and connectors 41. The transmission cable 4 has two ends having connectors 41, 42. One end is a male connector 41 which can be mounted onto the female socket 34 on the call-transferring box to provide effective connection and transmission. The other end is for the connection of connector 42 for entertainment work application and communication audio supply so that the signal is transmitted to the earphone cum microphone device. In other words, in operating the present earphone cum microphone device, appropriate type of transmission cable or wire 4 is changed can form linkage with the sound supply without changing the entire earphone cum microphone.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-functional earphone cum microphone device with independent transmission connector comprising an earphone, a microphone, a call-transferring box and transmission cable or wire, characterized in that the earphone includes a main earphone and a secondary earphone being connected by a connection wire, and from the interior of the main earphone, a specific length of earphone signal wire is extended and the end head of the signal wire is mounted with the call-transferring box having a connection male socket for the linkage with connector of any transmission source.

2. The multi-functional earphone cum microphone of claim 1, wherein the call-transferring box is a minute box body having on/off switches, volume adjusting button, microphone receiving port and components of corresponding socket.

3. The multi-functional earphone cum microphone of claim 1, wherein the microphone is mounted either within the box body of the earphone cum microphone device or is connected separately.

4. The multi-functional earphone cum microphone of claim 1, wherein the transmission wire comprises two ends provided respectively with a male connector at one end to connect with the female socket on the call-transferring box and a connector for connecting with entertainment work application and communication audio supplies.
